(19) United States
(12) Patent Application Publication
(10) Pub. No.: US 2007/0285040 A1
(43) Pub. Date: Dec. 13, 2007

(54) Synthetic Nervous System for Robotics

(75) Inventor: Thomas W. Jenner JR., Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: New School Technologies, LLC, Mercer Island, WA (US)

(21) Appl. No.: 10/586,977

(22) PCT Filed: Jan. 27, 2005
(86) PCT No.: PCT/US05/03412

§ 371 Date: Jul. 2, 2007

Related U.S. Application Data
(60) Provisional application No. 60/539,822, filed on Jan. 27, 2004.

(51) Int. Cl. B25J 9/16

(52) U.S. Cl. 318/568.1; 901/2

(57) ABSTRACT

A synthetic nervous system (10) capable of rudimental learning and self-organization for robotic applications having a control circuit (190) and servo actuators (224) using oscillating continuously variable analog voltages to mimic natural bio-neural processes. Simple oscillators (1-8) capable of being modulated in frequency, phase, amplitude, and DC offset act as analog processing elements or oscillating infinite state machines. A central pattern generator (140) utilizing periodic, quasi-periodic, or chaotic oscillators or phase shifters, or a combination thereof, along with a basic motor neuron circuit (314) enables multiple servos to coordinate their behavior to enable bio-inspired locomotion such as walking, swimming, flapping, crawling, and the like. Sensors (200) interfaced to the control circuit (190) provide a wide range of adaptive behavior such as following a light source, avoiding an obstacle, and shifting balance point. Overlapping or concurrent sensor input can provide complex behavior with minimal circuitry.

### BACKGROUND OF THE INVENTION

1. Field of the Invention

The present invention is directed to robotic control systems and, more particularly, to analog circuitry that simulates natural neurons, including a central pattern generator utilizing the multiple domains of frequency, phase, amplitude, and DC offset, and to a continuously variable analog synthetic nervous system.

2. Description of the Related Art

Robotic designs attempt to simulate the movement patterns of animals. With the exception of some lower invertebrates, animals have a nervous network that utilizes a central pattern generator to coordinate and synchronize the movements of their muscles. The central pattern generator has a pacemaker neuron functioning as a simple oscillator that does not require an input. The pacemaker neuron, when combined with a phase shifting network or interacting pacemaker neurons, causes the generation of an oscillating signal that is received at the muscle tissue through inter-neurons and motor neurons. In the time domain, these neurons communicate via voltage spikes. In other words, output voltage pulses are generated that can be measured in cycles per second.

This form of communication can be effective and robust, especially in the noisy environment where signal attenuation may occur over a long distance, e.g., from the spinal cord to a human hand.

A substantial amount of research has taken place in this field with respect to robotics and artificial life. This research and its resulting applications tends to be not only complex but also expensive. Very complex circuits using custom silicon and digital signal processors have been created to simulate how a natural central processing generator and nervous system work. Others have attempted to create simple nervous network systems for robots. One example is found in U.S. Pat. No. 5,325,031 issued to Tilden on Jun. 28, 1994. Tilden describes an adaptive robotic nervous system and control circuit for use with a limbed robot that utilizes a reconfigurable central network oscillator to sequence the processes of the robotic legs, each of which is itself autonomous. A pulse delay circuit is provided that, when connected to a second pulse delay circuit, acts as an artificial neuron. The device of Tilden suffers from several disadvantages, one of which is that the actuated limb has no way of detecting where it is in its phase space, and hence it limits feedback control beyond motor power consumption. In addition, Tilden utilizes Schmidt triggers in the central pattern oscillator that fire at one voltage and reset at a lower voltage to give a digital output, thus failing to take full advantage of the benefits of analog circuitry.

### BRIEF SUMMARY OF THE INVENTION

The disclosed embodiments of the invention are directed to robotic systems, and particularly to control circuits for robotic systems utilizing a basic motor neuron circuit that synthesizes all forms of limbed, finned, and undulating robotic locomotion. In one embodiment, an oscillating infinite state machine approach is used wherein analog circuits utilizing off-the-shelf servo motors, particularly those used in radio controlled aircraft and model cars, provide a simplified and cost-effective method for controlling locomotion and other robotic movement.

More specifically, in one embodiment of the invention analog electronic circuitry is provided that includes a plurality of basic motor neuron circuits controlled by a central pattern generator circuit to provide a continuously variable analog voltage. This voltage enables multiple motor neurons to coordinate their behavior and allow such robotic activities as walking, swimming, flapping, crawling, etc. By interfacing sensors to the synthetic nervous system, a wide range of adaptive behavior can be simulated by the robot, e.g., following a light, avoiding an obstacle, shifting a balance point, and the like.

In accordance with another embodiment of the invention, a control circuit for an actuator is provided. The control circuit includes an analog central pattern generator circuit structured to generate a sine wave shaped control signal at an output and an analog multi-vibrator circuit having an input coupled to the output of the central pattern generator and an output configured to be coupled to the actuator. The analog multi-vibrator circuit is structured to generate a sine-variable rectangular wave signal in response to the control signal from the central pattern generator to drive the servo in a smooth sine movement pattern.

In accordance with another embodiment of the invention, a basic motor neuron circuit is provided. This circuit includes a first transistor having a control terminal coupled to an input, a first terminal coupled to a voltage source and a second terminal; a second transistor having a control terminal coupled to the second terminal of the first transistor, a first terminal coupled to the voltage source and to an output, and a second terminal coupled to a reference voltage; and a third transistor having a control terminal coupled to the output and to the voltage source, a first terminal coupled to the voltage source, and a second terminal coupled to the reference voltage. Ideally, bipolar or integrated NPN or PNP transistors are used.

In accordance with another aspect of the foregoing embodiment, this basic motor neuron circuit preferably includes a first capacitor coupled between the control terminal of the third transistor and the output, and a second capacitor coupled between the first terminal of the third transistor and the control terminal of the second transistor, the first and second capacitors configured to control timing for the circuit.

In accordance with another embodiment of the invention, the basic motor neuron circuit includes a first resistor and a second resistor coupled in series between the control terminal of the second transistor and the voltage source and configured to control a pulse width of a pulse signal generated on the output.

In accordance with yet another aspect of the invention, a robotic system is provided having at least one movable component coupled to a servo that generates movement of the component, the robotic machine including: a control circuit coupled to the servo for controlling actuation of the servo, the control circuit including: a first transistor having a control terminal coupled to an input, a first terminal coupled to a voltage source and a second terminal; a second transistor having a control terminal coupled to the second terminal of the first transistor, a first terminal coupled to the voltage source and to an output, and a second terminal coupled to a reference voltage; and a third transistor having a control terminal coupled to the output and to the voltage source, a first terminal coupled to the voltage source, and a second terminal coupled to the reference voltage.

In accordance with yet a further embodiment of the invention, a synthetic nervous system for robotic applications having a control circuit and servo actuators using continuously variable analog voltages to mimic natural bio-neural processes is provided that includes a central pattern generator utilizing periodic, quasi-periodic, or chaotic oscillators or phase shifters, or a combination thereof, along with a basic motor neuron circuit. Ideally the system enables multiple motor neurons to coordinate their behavior to enable such things as walking, swimming, flapping, crawling, and the like. Sensors interfaced to the control circuit provide a wide range of adaptive behavior such as following light, avoiding an obstacle, and shifting a balance point. Overlapping or concurrent behavior can provide complex behaviors with minimal circuitry.

As will be readily appreciated from the foregoing, the approach of the present invention is fundamentally different from prior designs. Some contemporary systems use an integrate-and-fire design to robotics locomotion control using an adaptive ring oscillator while the present invention uses simple phased, coupled continuously variable analog logic and oscillators implemented as oscillating infinite state machines that can be modulated in frequency, phase, amplitude, and DC offset. These oscillators are used as computational elements capable of maximizing processing power while minimizing circuitry.

### BRIEF DESCRIPTION OF THE DRAWINGS

The foregoing and other features and advantages of the present invention will be more readily appreciated as the same become better understood from the following detailed description when taken in conjunction with the accompanying drawings, wherein:

FIG. 1 is a circuit diagram of a basic motor neuron circuit formed in accordance with the present invention;

FIG. 2 is a circuit diagram of a master-slave central pattern generator formed in accordance with the present invention;

FIG. 3 is a frequency-modulated central pattern generator formed in accordance with the present invention;

FIG. 4 is a circuit diagram of a variable master-slave central pattern generator formed in accordance with the present invention;

FIG. 5 is a circuit diagram of an amplitude modulator circuit for use with a central pattern generator formed in accordance with the present invention;

FIG. 6 is an illustration of a DC offset modulator circuit for use with the basic motor neuron circuit and central pattern generator circuits;

FIG. 7 is a diagram of a control circuit for a four-legged eight-servo light-seeking robotic walker formed in accordance with the present invention;

FIG. 8 is a diagram illustrating the topology of a synthetic nervous system formed in accordance with the present invention;

FIG. 9 is a schematic of a motor neuron circuit utilizing a 555 timer chip formed in accordance with the present invention;

FIGS. 10A-10C are circuit schematics for a short-term memory as used for a two-servo walker with an analog input formed in accordance with the present invention;

FIG. 11 is a circuit schematic of an alternative central pattern generator utilizing a NE567 tone decoder chip in accordance with the present invention;

FIG. 12 is a circuit schematic for an eight-transistor two-servo photowalker formed in accordance with the present invention;

FIGS. 13A-13B are a circuit schematic and corresponding topology diagram of a control circuit for a two-servo walking light follower formed in accordance with the present invention;

FIGS. 14A through 14D are a topology diagram and accompanying circuit schematics for a phase switch matrix control circuit and voltage-to-position converter configured for use with a four-legged eight-servo walker formed in accordance with the present invention;

FIGS. 15A and 15B are a circuit schematic and accompanying topology diagram for a learning connectionist synapse formed in accordance with the present invention;

FIGS. 16A and 16B are a circuit schematic and corresponding topology diagram for a learning connectionist neuron formed in accordance with the present invention;

FIG. 17 is a topology diagram of an input synapse array formed in accordance with the present invention;

FIG. 18A is an oscilloscope waveform diagram of the outputs of the master-slave central pattern generator of FIG. 2;

FIG. 19 is an oscilloscope waveform diagram of the output from a modified central pattern generator for use with a four-legged eight-servo walker;

FIG. 20 is an oscilloscope waveform diagram of the output of a modified central pattern generator for use with a four-legged eight-transistor walker; and

FIG. 21 is an oscilloscope waveform diagram illustrating the output of a near-chaotic central pattern generator formed in accordance with the present invention.

### DETAILED DESCRIPTION OF THE INVENTION

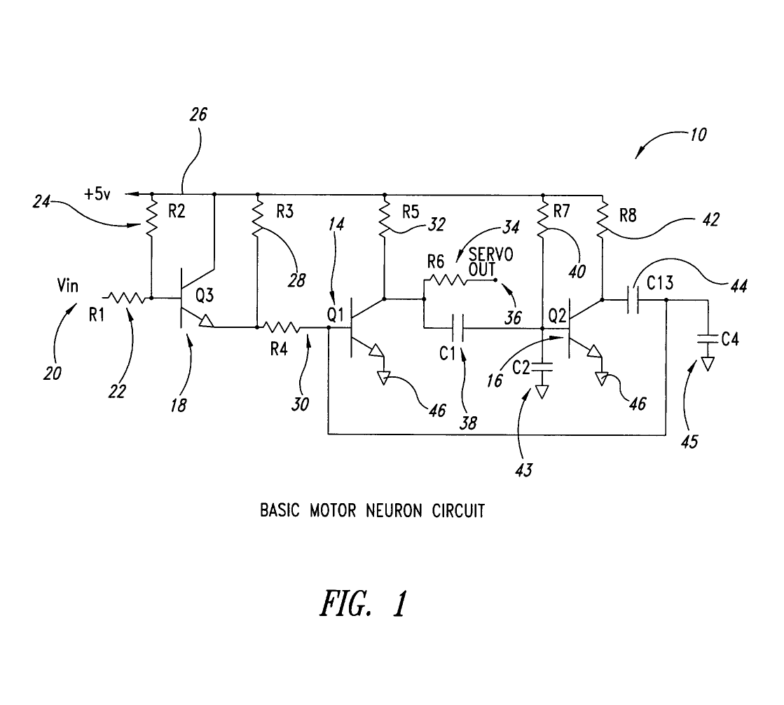

FIG. 1 is a circuit diagram of a basic motor neuron circuit 10 formed in accordance with one embodiment of the invention. This circuit is configured as a waveform generator for use with commercially available model-hobbyist type servos. The circuit 10 includes a rectangular wave multi-vibrator circuit formed of a first transistor (Q1) 14 and a second transistor (Q2) 16. A third transistor (Q3) 18 is configured to operate as a voltage-controlled resistor and is coupled between an input 20 (Vin) and a control terminal or base of the first transistor 14. A first resistor 22 (R1) is coupled between the input 20 and the control terminal or base of the third transistor 18, and a second resistor 24 (R2) is coupled between the control terminal or base of the third transistor 18 and a voltage source 26, which is preferably set at 5 volts for this application. The second resistor 24 provides a bias to the third transistor 18 so that it operates in the linear region and, functionally, as a voltage-controlled resistor.

The third transistor 18 has a first terminal coupled to the voltage source 26 and a second terminal coupled to the voltage source 26 through a third resistor 28 (R3) and also to a control terminal of the first transistor 14 via a fourth resistor 30 (R4). The first transistor 14 has a first terminal coupled to the voltage source 26 via a fifth resistor 32 (R5) and also coupled via a sixth resistor 34 (R6) to an output 36 (SERVO OUT). In addition, the first terminal of the first transistor 14 is also coupled to a control terminal of the second transistor 16 via a first capacitor 38 (C1). The control terminal of the second transistor 16 is also coupled to the voltage source 26 via a seventh resistor 40 (R7) and to ground or a reference potential 46 through a second capacitor 43 (C2). The first terminal of the second transistor 16 is coupled to the voltage source 26 via an eighth resistor 42 (R8) and to the control terminal of the first transistor 14 via a third capacitor 44 (C3). The second terminals of the first and second transistors 14, 16 are coupled to a common reference potential 46, shown in this example with a ground symbol. A fourth capacitor 45 (C4) is coupled between the base of Q1 and ground 46.

As described above, the first and second transistors 14, 16 are coupled together to function as a square wave multi-vibrator. The fifth resistor 32 and the eighth resistor 42 are chosen to obtain a desired waveform at the output 36. The first and third capacitors 38, 44 are the timing capacitors for the circuit 10. The seventh resistor 40 controls the time between pulses at the output 36, and the value of this resistor is not critical so long as it provides pulses in the range of 20 milliseconds to 50 milliseconds. The third and fourth resistors, 28, 30 along with the third transistor 18 control the length of the pulse. Preferably, the third and fourth resistors 28, 30 are chosen to give about a 2-millisecond pulse, but the fourth resistor 30 can be variable to choose whatever is appropriate for the circuit.

The Vin input 20 functions as a signal summation point for the output of other circuits to be described below. Zero volts at the Vin input 20 provides roughly a 2-millisecond pulse at the output 36, and 5 volts at the input 20 provides approximately 1-millisecond pulses. These pulses are preferably provided directly to a commercially available servo (not shown in FIG. 1) that has an input coupled to the output 36 of the circuit 10.

Bipolar or integrated NPN transistors are used in this basic motor neuron circuit 10. While operational amplifiers can be used, such as those fabricated using CMOS technology, cost and simplification is a goal and hence operational amplifiers are not preferred for this circuit.

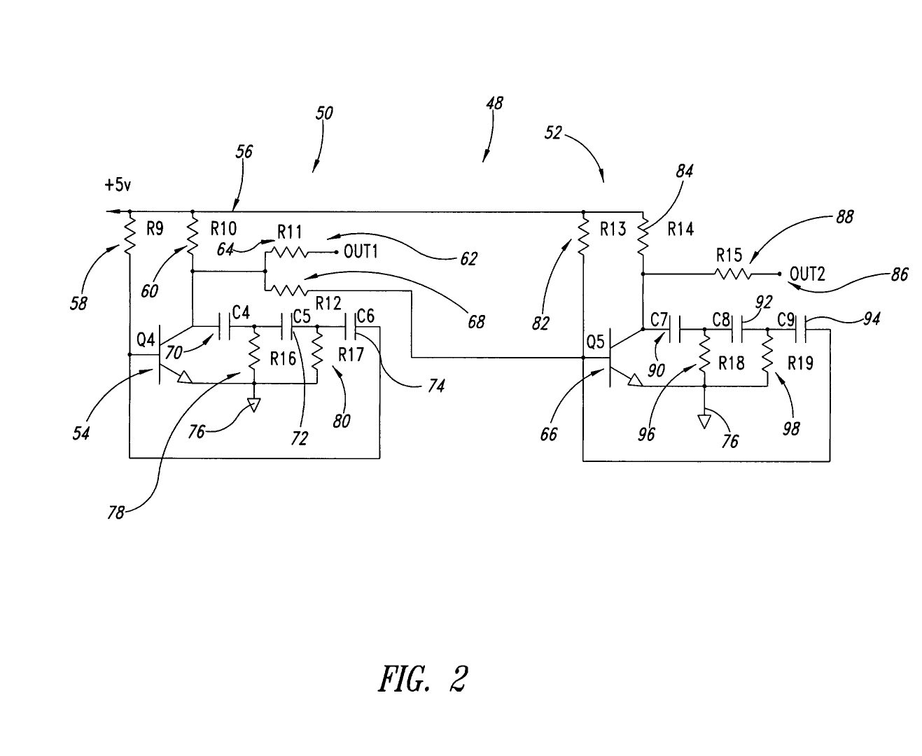

Turning next to FIG. 2, shown therein is a master-slave central pattern generator circuit 48 formed in accordance with the present invention to include a first section 50 and a second section 52. The first section 50 includes a fourth transistor (Q4) 54 having a control terminal coupled to a voltage source 56, which could be the same voltage source 26 used with the basic motor neuron circuit 10 when these circuits are coupled together. A ninth resistor 58 (R9) is interposed between the voltage source 56 and the control terminal of the fourth transistor 54. The fourth transistor 54 has a first terminal coupled to the voltage source 56 via a tenth resistor 60 (R10) and also coupled to an output 62 (OUT1) via an eleventh resistor 64 (R11). The first terminal of the fourth transistor 54 is also coupled to the control terminal of a fifth transistor (Q5) 66 via a twelfth resistor 68 (R12).

The fourth transistor 54 also has its first terminal coupled to its control terminal via a fourth capacitor 70 (C4), fifth capacitor 72 (C5), and sixth capacitor 74 (C6) series coupled together. A second terminal of the fourth transistor 54 is coupled to a ground or reference potential 76 and to a sixteenth resistor 78 (R16) that is coupled between the fourth and fifth capacitors 70, 72 and to a seventeenth resistor 80 (R17) coupled between the fifth capacitor 72 and the sixth capacitor 74.

Turning to the second section 52, this section includes the fifth transistor 66 in which the control terminal is coupled to the voltage source 56 via a thirteenth resistor 82 (R13), a first terminal is coupled to the voltage source 56 via a fourteenth resistor 84 (R14), and to an output 86 (OUT2) via a fifteenth resistor 88 (R15). In addition, the fifth transistor 66 has its first terminal coupled to its control by series connected seventh, eighth, and ninth capacitors 90, 92, 94. The second terminal of the fifth transistor 66 is coupled to the ground or reference potential 76, and to an eighteenth resistor 96 (R18) coupled between the seventh and eighth capacitors 90, 92, and to a nineteenth resistor 98 (R19) coupled between the eighth and ninth capacitors 92, 94.

In operation, the first and second sections 50, 52 are single transistor sine wave oscillators. The sixteenth through the nineteenth resistors 78, 80, and 96, 98 and the fourth through the ninth capacitors 70, 72, 74, and 90, 92, 94 cooperate to provide the RC timing constants. The RC time constant should be in the range of 0.5 to 3.0 seconds for the robotic applications disclosed herein. The time constant can be varied as necessary to meet the needs of a particular application. The value of the ninth, tenth, thirteenth and fourteenth resistors 58, 60, 82, 84 are chosen for best waveform output. Each of the first and second oscillators 50, 52 has its own basic motor neuron output 62, 86 through the eleventh resistor 64 and the fifteenth resistor 88, respectively. The first section 50 has its output coupled OUT1 to the input 20 of the basic motor neuron circuit 10 shown in FIG. 1. The second output 86 (OUT2) is likewise coupled to a basic motor neuron circuit for actuating a second servo (not shown). The second section 52 is a slave that is out of phase with the first section 50. The central pattern generator 48 does not have an input and commences generating a single sine wave at the OUT1 output 62 of the first section 50 upon power-up.

The first and section sections 50, 52 are lightly coupled together through the twelfth resistor 68. In this manner, the second section 52 becomes phase locked and phase shifted with respect to the first section 50. The first, second, and fourth periods and chaotic phase orbits of these circuits can be measured at the twelfth resistor 68 and a fifteenth resistor 88 with proper adjustment of the tenth resistor 60 and the fourteenth resistor 84, which are used to modify the sine wave output.

By coupling the output 62 of the first section 50 to the input 20 of the basic motor neuron circuit 10, a sine variable rectangular waveform will appear at the output 36 of the basic motor neuron circuit 10, which is used as an input to a servo or actuator (not shown in this FIGURE). This will cause a rotatable shaft in the servo to turn back and forth in a smooth sine pattern. This back-and-forth motion forms the basic action of robotic locomotion in a synthetic nervous system consisting of the basic motor neuron circuit 10 and the central pattern generator circuit 48.

Adding an additional RC pole to the central pattern generator sine wave signal will provide greater oscillator stability and modify the sine wave so that it may be more appropriate to certain locomotion schemes.

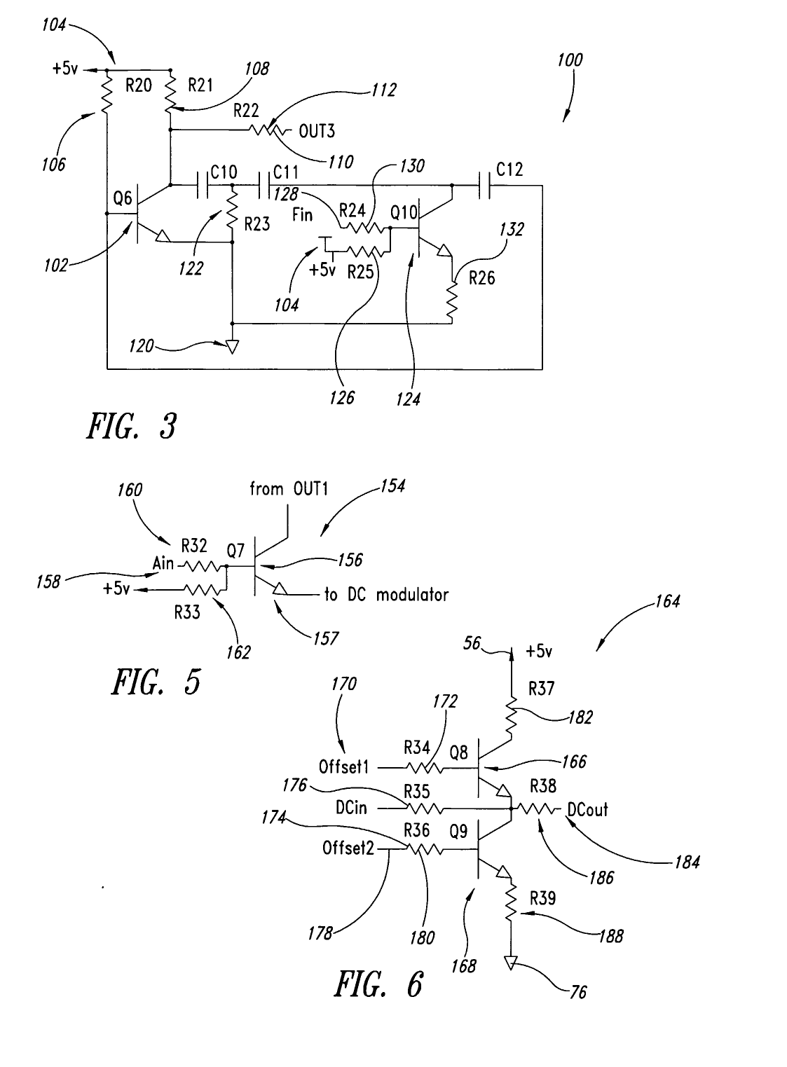

Turning next to FIG. 3, shown therein is a frequency modulated central pattern generator circuit 100 formed in accordance with another embodiment of the present invention. This circuit 100 includes a sixth transistor 102 (Q6) having its control terminal coupled to a voltage source 104 via a twentieth resistor 106 (R20), and having its first terminal also coupled to the voltage source 104 via a twenty-first resistor 108 (R21). The first terminal is also coupled to an output 110 (OUT3) via a twenty-second resistor 112 (R22) and to its control terminal by series coupled tenth, eleventh, and twelfth capacitors 114, 116, 118. The sixth transistor also has a second terminal that is coupled to a ground or reference potential 120 and to a twenty-third resistor 122 (R23) that has its other terminal coupled between the tenth and eleventh capacitors 114, 116. A tenth transistor 124 (Q10) has its control terminal coupled to a 5-volt voltage source, such as the voltage source 104 referenced above, via a twenty-fifth resistor 126 (R25) and also coupled to a frequency input terminal 128 via a twenty-fourth resistor 130 (R24). This tenth transistor 124 has a first terminal coupled between the eleventh and twelfth capacitors 116, 118 and a second terminal coupled to the ground or reference potential 120 via a twenty-sixth resistor 132 (R26).

This frequency-modulated central pattern generator circuit 100 is configured to replace one of the RC timing resistors, such as the nineteenth resistor 98 in the master-slave central pattern generator 48 or the seventeenth resistor 80 in the first section 50 thereof. For example, if the nineteenth resistor 98 were replaced with the frequency-modulated central pattern generator circuit 100, the output 110 (OUT3) of the central pattern generator circuit 100 would be coupled between the eighth and ninth capacitors 92, 94. The twenty-fourth through the twenty-sixth resistors 130, 126, 132, respectively, and the sixth transistor 102 cooperate to act as a high-impedance voltage controlled resistor. This enables modification of the central pattern generator 48 so that it can be sped up or slowed down, and it also allows for more complex waveforms. Thus, this central pattern generator circuit 100 provides for frequency modification of the central pattern generator 48 of FIG. 2 and hence of the basic motor neuron circuit 10. In use this circuit controls the speed of movement from walking to running.

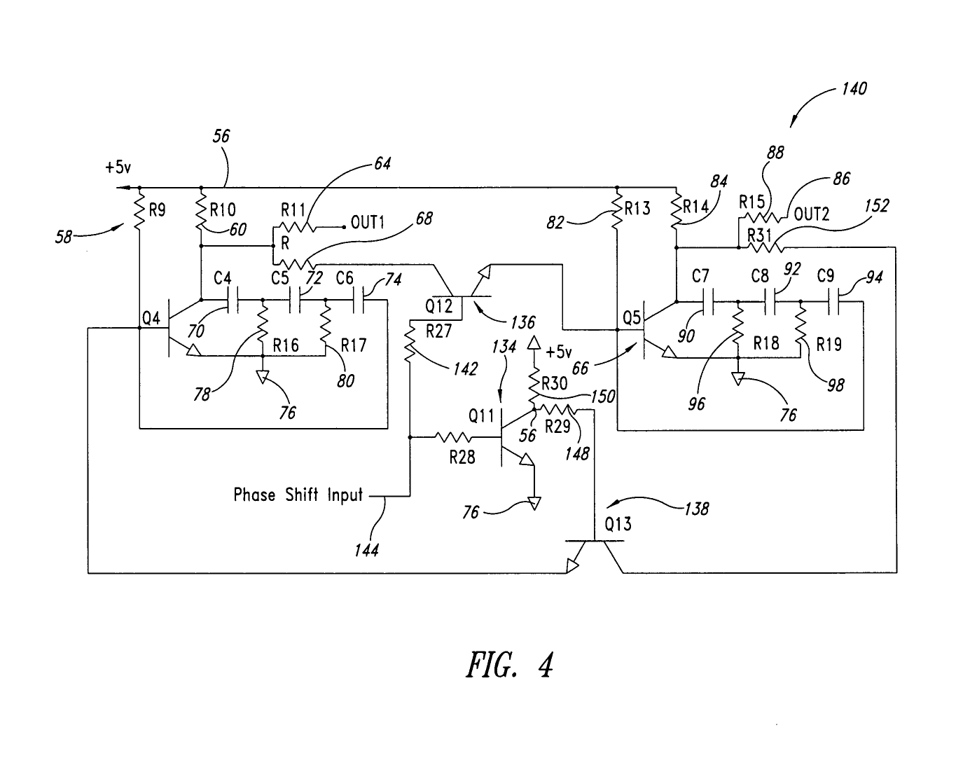

Turning next to FIG. 4, shown therein is a variable master-slave central pattern generator circuit 140 modified to enable phase shifting of the output signal, which allows reversing of the circuit and hence the motion of the servo connected at the output 36 (SERVO OUT) of the basic motor neuron circuit 10 shown in FIG. 1. In FIG. 4, elements in common with those shown in FIG. 2 have the same reference number. Here, eleventh, twelfth, and thirteenth transistors 134, 136, 138 (Q11, Q12, Q13) are added to the circuit 48 of FIG. 2 to form the variable master-slave central pattern generator circuit 140. The twelfth transistor 136 has a control terminal coupled to a phase shift input 144 via a twenty-seventh resistor 142 (R27), and a first terminal coupled to the twelfth resistor 68. A second terminal of the twelfth transistor 136 is coupled directly to the control of the fifth transistor 66. The eleventh transistor 134 has a control terminal coupled to the phase shift input 144 via a twenty-eighth resistor 146 (R28), a first terminal coupled to the 5-volt voltage source 56, and a second terminal coupled to the control of the thirteenth transistor 138 by a twenty-ninth resistor 148 (R29) and to the positive voltage reference potential 76 via a thirtieth resistor 150 (R30). Finally, the thirteenth transistor 138 has its first terminal coupled to the first terminal of the fifth transistor 66 via a thirty-first resistor 152 (R31) and its second terminal coupled directly to the control of the fourth transistor 54.

In this modified variable central pattern generator 140, the eleventh transistor 134 (Q11) receives a O-volt to 5-volt phase shift input signal at the phase shift input 144 to invert the phase shift signal so that only the twelfth or thirteenth transistor 136, 138, (Q12, Q13) respectively, is on at any one time. These two transistors are structured to control the flow of information, and this simple arrangement allows the twelfth transistor 136 to be phase shifted from about 90 degrees to 270 degrees in relation to the thirteenth transistor 138, enabling simple reversing of the robotic direction.

Amplitude modulation of the sine wave output signal generated by the central pattern generator 48, 140 is provided via an amplitude modulator circuit 154 shown in FIG. 5. Here, a seventh transistor (Q7) 156 has its control terminal coupled to an amplitude input 158 via a thirty-second resistor 160 (R31) and to a voltage source, such as voltage source 56, via a thirty-third resistor 162. The first terminal of the seventh transistor 156 is coupled to the output 62 (OUT1) of the first section 50, and the second terminal 157 of this transistor forms the output of the amplitude modulator circuit 154, which is received at a DC offset modulator circuit 164 in FIG. 6. An amplitude input control signal is received at the amplitude input 158. The amplitude modulator circuit is used to control the amount of limb swing or rotation, such as length of stride.

Turning to FIG. 6, the DC offset modulator circuit 164 consists of series-coupled eighth and ninth transistors 166, 168 (Q8, Q9) in which the control terminal of the eighth transistor 166 is coupled to a first offset input 170 (Offset1) via a thirty-fourth resistor 172 (R34), a second terminal is coupled to a DC input 174 (DCin) via a thirty-fifth resistor 176 (R34). The ninth transistor 168 has a control terminal coupled to a second DC offset input 178 (Offset2) via a thirty-sixth resistor 180 (R36).

The eighth transistor 166 also has a first terminal coupled to a voltage source 56 via a thirty-seventh resistor 182 (R37), and its second terminal is also coupled to a DC output 184 (DCout) via a thirty-eighth resistor 186 (R38). The ninth transistor 168 has its first terminal coupled to the second terminal of the eighth transistor 166 and hence to the thirty-eighth resistor 186. A second terminal of the ninth transistor 168 is coupled to the ground reference potential 76 via a thirty-ninth resistor 188 (R39).

The DC offset modulator circuit 164 is configured so that the DC input 174 is coupled to the second terminal 157 of the seventh transistor 156 in the amplitude modulator circuit 154. The DC output 184 is then coupled to the Vin input 20 of the basic motor neuron circuit 10 of FIG. 1. The DC offset modulator circuit 164 is utilized for balancing and steering of the robotic machine in combination with the amplitude modulator circuit 154 of FIG. 5. The amplitude modulator circuit 154 provides for amplitude adjustment of the sine wave output from the sine wave oscillator of the first section 50.

The DC output 184 from the DC offset modulator 164 and the output 110 from the frequency-modulated central pattern generator circuit 100 are configured to be summed at the Vin input 20 of the basic motor neuron circuit 10 to provide full control of the servos and the resulting movement of the robotic machine. For example, DC offset to one set of servos will cause turning of the robotic walker machine.

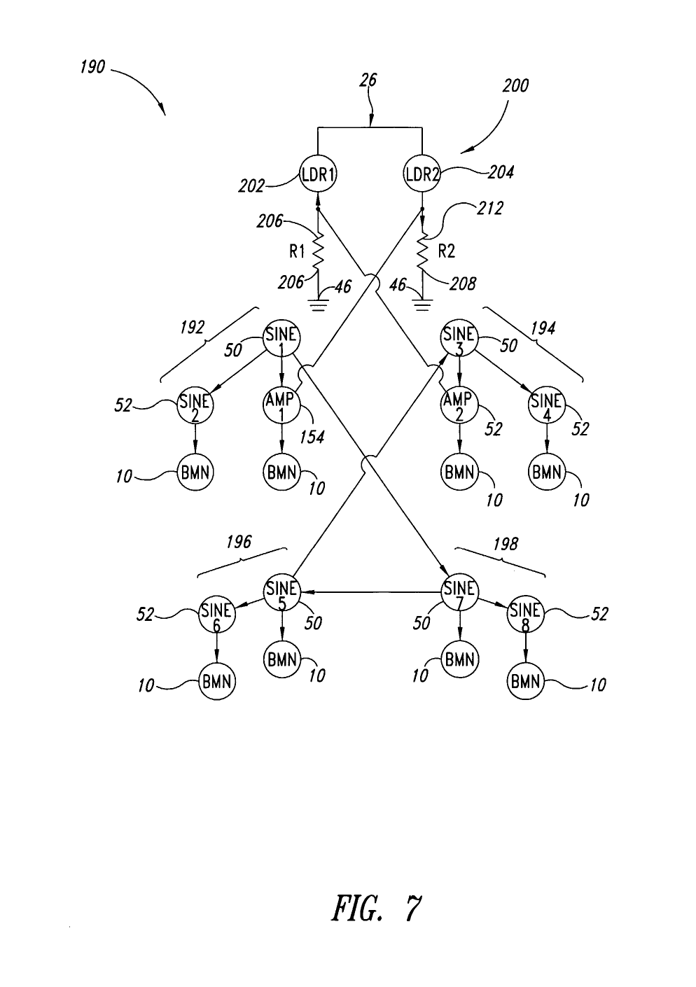

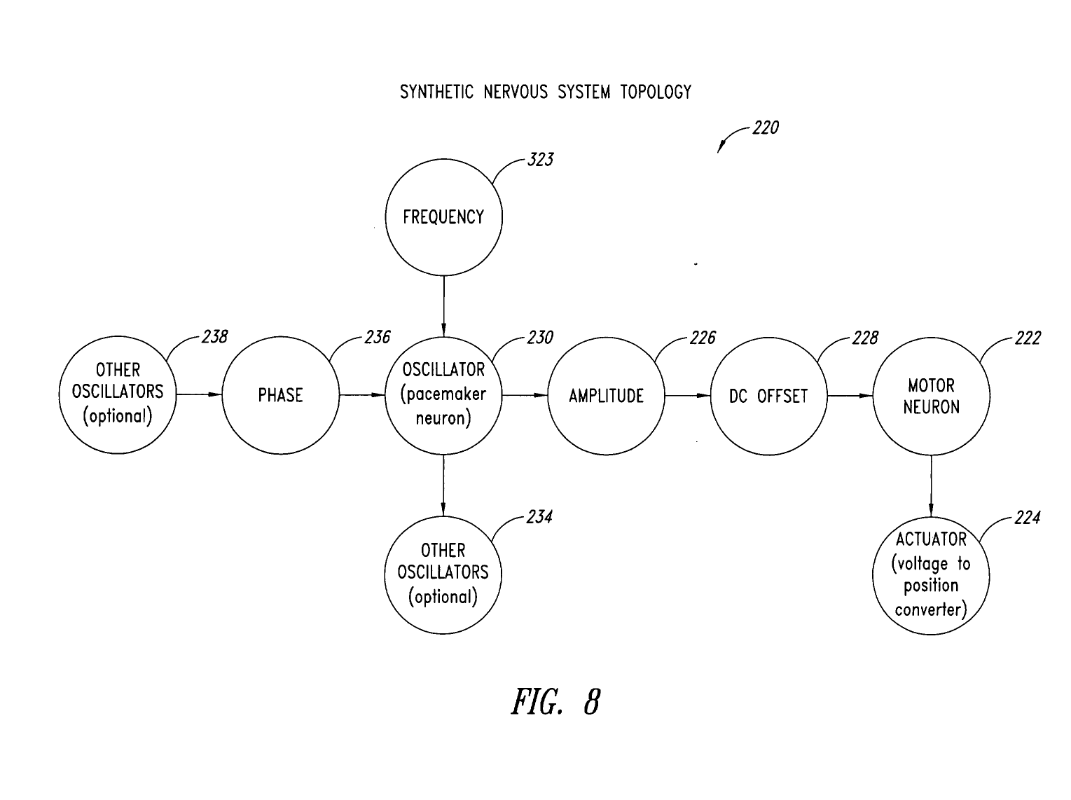

FIG. 7 is a synthetic nervous system or control circuit 190 for a four-legged eight-servo light-seeking robotic walker machine. The control circuit 190 in one embodiment utilizes sixteen oscillators and thirty-four transistors, preferably NPN transistors, arranged as a synthetic nervous system. Pairs of sine oscillators are configured as central pattern generators 48, shown in FIG. 2, to control each leg of the robotic machine. More particularly, a first leg control circuit 192 includes oscillators Sine 1 and Sine 2, which are the first and second sections 50, 52 of the central pattern generator 48 of FIG. 2. Coupled to Sine 1 is the amplitude modulator circuit 154 that in turn is coupled to the basic motor neuron circuit 10 of FIG. 1, as is Sine 2, which is coupled to the output 86 from the second section 52 for the basic motor neuron circuit 10.

Similar construction is used for the second leg control circuit 194. The third and fourth leg control circuits 196, 198 only utilize the central pattern generator 48 and the basic motor neuron circuit 10.

Sine oscillators 1, 3, 5, and 7 are configured to control forwards and backwards leg swing while Sine oscillators 2, 4, 6, and 8 are configured to control the up and down movements of the leg. Amps 1 and 2 are the amplitude modulator circuits 154 of FIG. 5 that are controlled through a cross-connected light-dependent sensor circuit 200. The sensor circuit 200 consists of a first light dependent resistor 202 and second light dependent resistor 204 powered by the voltage source 26, preferably at 5 volts, and connected to ground reference potential 46 via first and second resistive elements 206, 208. A first output node 210 is formed at the connection between the first resistive element 206 and the first light dependent resistor 202, and a second output node 212 is formed at the connection between the second resistive element 208 and the second light dependent resistor 204. The first output node 210 is coupled to the amplitude input 158 of Amp 2, and the second output node 212 is coupled to the amplitude input 158 of Amp 1. This controls the amount of swing in the front legs in proportion to the amount of light received at the light dependent resistors 202, 204. Cross-tying the light dependent resistors 202, 204 enables light-seeking behavior by the robotic machine.

The collector of Sine 1 is wired to the base of Sine 7, as is the collector of Sine 1 wired to the base of Sine 2. Sine 1 and 7 are locked about 90 degrees out of phase. Sine 7 is connected to Sine 5 and 8 in the same collector-to-base fashion. Sine 5 is connected to Sine 3 and 6, and Sine 3 is connected to Sine 4. Ideally, these connections are made through a resistor, preferably of a value similar to the value of resistor 68 (R9) of FIG. 2.

All of the leg pairs 192, 194, 196, 198 are phase locked roughly 90 degrees from each other. On an oscilloscope in the “XY” setting, this will show a roughly circular phase orbit. When connected to the basic motor neuron circuit 10 and wired to a servo, this will cause the legs to show forward locomotion.

Because Sine oscillators 1, 7, 5, and 3 are roughly 90 degrees out of phase, this will cause each leg in the robotic machine to swing forward in proper phase unison. Because Sine oscillators 2, 4, 6, and 8 are driven by the second section 52, which is phase shifted from the first section 50, this will coordinate lifting of the legs at the time the legs are moving forward, thus enabling a forward walking motion. Amps 1 and 2 control the amount of leg swing through signals received from the light sensor circuit 200 to enable the robotic machine or quadropod to walk towards a light source.

As will be readily appreciated from the foregoing, the “basic motor neuron” circuit described above utilizes a two-transistor multi-vibrator in combination with a third transistor having a high impedance on its base that is functional as a voltage variable resistor. This circuit outputs ideally a 1-2 millisecond pulse train that is needed to control a servo. While an existing JFET MPF102 transistor has been used as the third transistor, much better and linear results using a less-expensive 2n222 NPN transistor can be obtained with lower cost and complexity. Other circuits, such as a 555 timer chip, op amps and diodes, can be used, but the preferred embodiment described above is in keeping with the goal of a straightforward, simple robust circuit. A chip such as the PIC 12F675, however, can be used in place of two basic motor neuron circuits, which replaces 30 or more electronic components by digitizing the oscillators and outputting a proper signal.

While the foregoing embodiment is still somewhat complicated, involving 34 transistors, 16 of them implemented as oscillators, 8 of which are phase-locked and some of which are phase-locked to multiple oscillators, a more simplified two-servo light-following walking robot can be built with a touch sensor that uses 555 timer chips to replace the transistors in the basic motor neuron circuit along with two phase-coupled sine oscillators. In one embodiment, two 555 timers, two transistors, two servos, and several passive sensors and components can be used to provide a substantial amount of processing power. Additional features and alternative embodiments of the present invention will now be described in conjunction with FIGS. 8-21. The goal here is to simplify the basic motor neuron circuit using a 555 timer design having only six external components, ideally working almost identical to the three-transistor basic motor neuron circuit described above. One 555 timer is needed per servo. The sine oscillators are identical to the ones described above.

Referring to FIG. 8, shown therein is a synthetic nervous system topology 220 for a single motor neuron 222 coupled to an actuator 224 such as a servo. FIG. 8 further shows amplitude and DC offset circuits 226, 228, respectively, series coupled as inputs to the motor neuron 222. An oscillator 230, such as a pacemaker neuron, receives a frequency input from a frequency circuit 232 and other optional oscillators 234 and a phase circuit 236 to generate an output that is received at the amplitude circuit 226. Further additional oscillators 238 can be used as input to the phase circuit 236, all in a manner as described above with respect to the embodiments depicted in FIGS. 1-7.

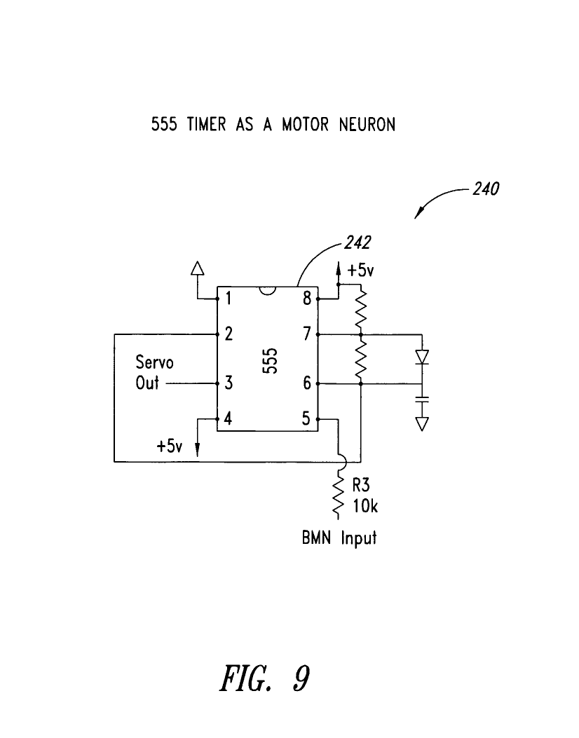

Turning next to FIG. 9, shown therein is an alternative embodiment of a basic motor neuron circuit 240 utilizing a 555 timer chip 242. As shown therein, pin 1 is coupled to ground and pin 8 is coupled to a 5-volt voltage source. Resistor R1 couples the voltage source to pin 7 and to a diode D1. A resistor R2 couples pin 7 to pin 6 and to pin 2. A capacitor C1 couples the diode D1 to ground. Pin 5 functions through resistor R3 as the input to the motor neuron circuit 240. Pin 4 is coupled to a 5-volt voltage source, while pin 3 serves as the output to the actuator.

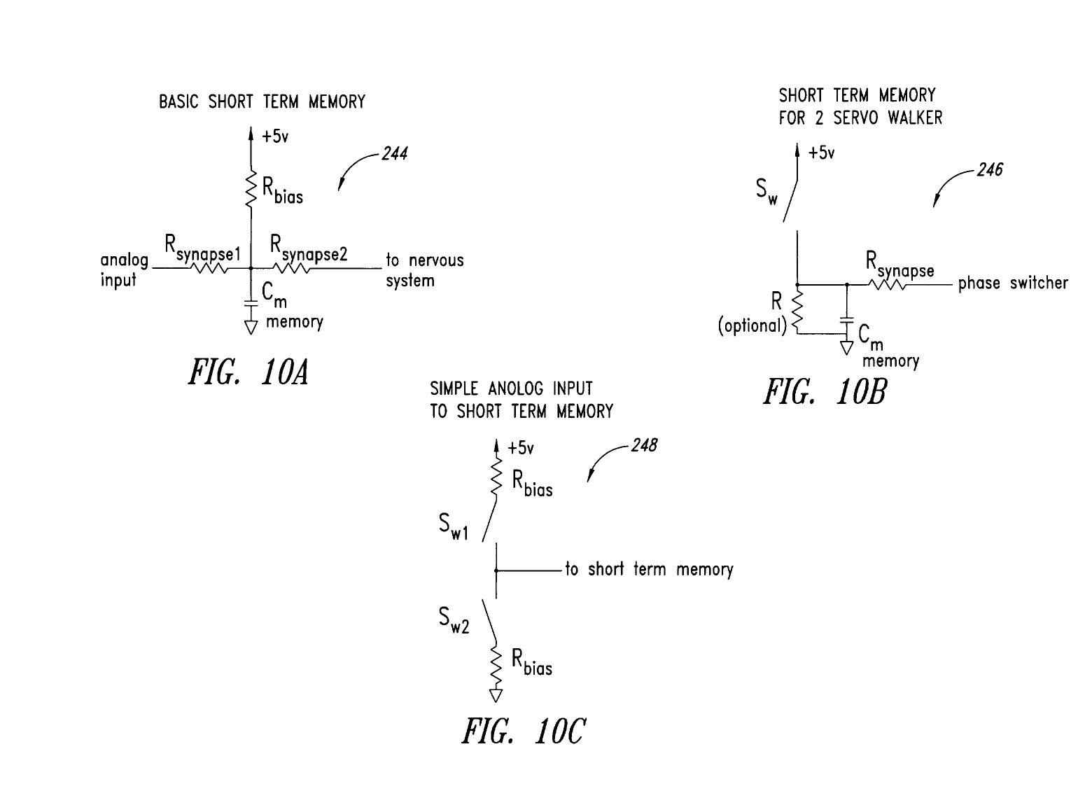

Turning next to FIGS. 10A-10C, shown therein are a basic short-term memory circuit 244, a short-term memory circuit 246 for a two-servo walker, and a simple analog input circuit 248 for the short-term memory circuit 246, respectively. The basic short-term memory 244 shown in FIG. 10A includes three resistors and a capacitor coupled to a common node. A synapse resistor has its free terminal functioning as an analog input to the short-term memory circuit 244. A bias resistor R_{bias} has its free terminal coupled to a 5-volt voltage source. A third resistor R_{synapse2} has its free terminal coupled to the nervous system, while the memory capacitor Cₘ has its free terminal coupled to ground. This is a preferred circuit for most of the applications of the present invention. The resistor R_{bias} prevents self-discharge. The circuit of FIG. 10A is utilized in controlling and influencing nervous system behavior, such as a bump switch, phase shifter, modulator, etc.

In FIG. 10B, the short-term memory circuit 246 has a switch Sw with one terminal coupled to a 5-volt voltage source and a second terminal coupled to resistor R_{synapse} and to a memory capacitor C_{memory} that has its free terminal coupled to ground. The connection between the switch Sw, capacitor C_{memory} and resistor R_{synapse} is optionally coupled to a ground through an optional resistor Rₒₚₜᵢₒₙₐₗ. The free terminal of the resistor R_{synapse} is coupled to a phase switcher.

FIG. 10C illustrates the simple analog input 248 to the short-term memory circuit 246 and includes a first bias resistor R_{bias}, having one terminal coupled to a 5-volt voltage source and a second terminal coupled to a switch that has its second terminal coupled to a second terminal of a second bias resistor R_{bias2}, whose free terminal is coupled to ground. The connection between the two bias resistors R_{bias1} and R_{bias2} serves as the output to the short-term memory 246. Thus, the analog input circuit 248 provides a convenient way to charge the capacitor C_{memory}, making the circuit self-adjusting, such as when a leg over-impacts a surface. This is used to adjust the DC offset modulation. Thus, the short-term memory circuit 246 can be considered as a combination of the basic short-term memory circuit 244 and the analog input circuit 248 for use in controlling phase switches to control functioning of the nervous system.

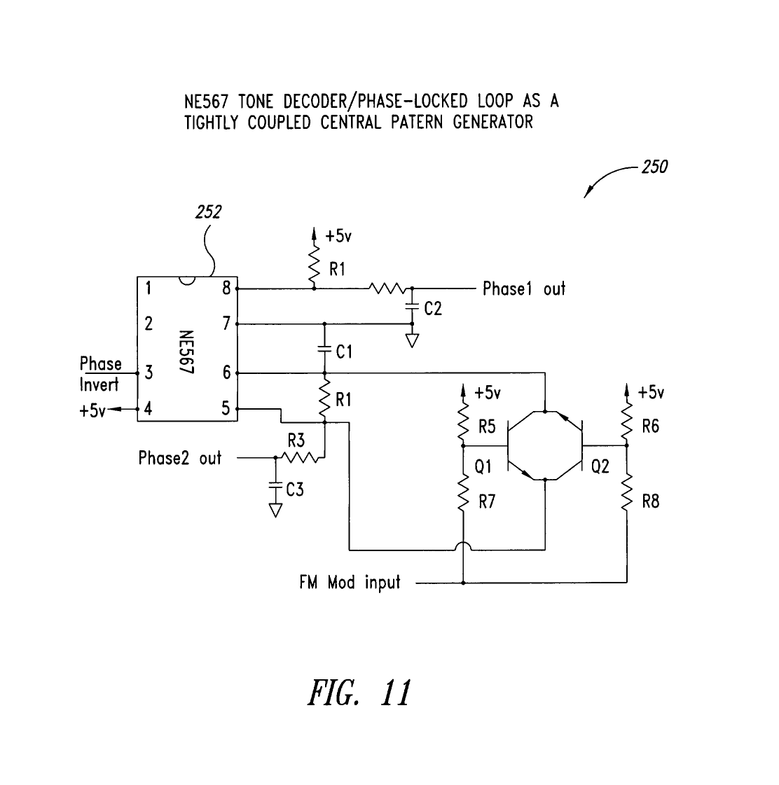

Turning next to FIG. 11, shown therein is an alternative embodiment of a central pattern generator circuit 250 that uses a quadrature oscillator with outputs going through a first order low-pass filter. More particularly, the central pattern generator circuit 250 utilizes an NE567 tone decoder/phase-locked loop chip 252 having pins 1 and 2 open, pin 3 coupled to a phase inverter, and pin 4 coupled to a 5-volt voltage source. Pin 8 is coupled to a 5-volt voltage source through a first resistor R1 and to a phase 1 output through resistor R2. Pin 7 is coupled to ground and to the phase 1 OUT through capacitor C2. The capacitor C1 coupled pin 7 to pin 6. Pin 6 is also coupled to pin 5 through resistor R4 and to a second output phase 2 OUT via resistor R3. The phase OUT is also coupled to ground through a capacitor C3. A first transistor Q1 and second transistor Q2 are coupled in reverse parallel relationship with the gate of Q1 coupled to a 5-volt voltage source through resistor R5 and to a frequency modulated input through resistor R7. A first terminal of resistor Q1 is coupled to the sixth pin of the chip 252 and a second terminal of Q1 is coupled to the fifth pin of the chip 252. The second terminal of Q1 is also coupled to the first terminal of Q2 which has its second terminal coupled to pin 6. The control terminal of transistor Q2 is coupled to the 5-volt voltage source through resistor R6 and coupled to the frequency modulated input through resistor R8.

As can be seen therein, resistors R1, R5, and R6 function as bias resistors, while resistors R2 and R3 are first order low-pass resistors. Resistor R4 is a timing resistor cooperating with capacitor C1, which is a timing capacitor. Capacitors C2 and C3 are first order low-pass capacitors, while transistors Q1 and Q2 function as a voltage variable resistor. Phase 1 OUT and phase 2 OUT are outputs to basic motor neuron circuits, while phase invert is a control signal to swap phases at appropriate voltages. The output of this central pattern generator is close to a sine wave with a built-in phase inverter to enable change in direction of the actuator or robot. Ideally, the phase 1 OUT and phase 2 OUT are 90 degrees out of phase to provide locomotion through two actuators.

It is to be understood that any appropriate analog oscillator can be used besides transistors and the 567 tone decoder disclosed herein. The advantage of transistors or operational amplifier oscillators is that they can be weakly phase-coupled to generate more complex waveforms. For high locomotion efficiency, phase-coupled oscillators should meet the Liapunov criterion for stability.

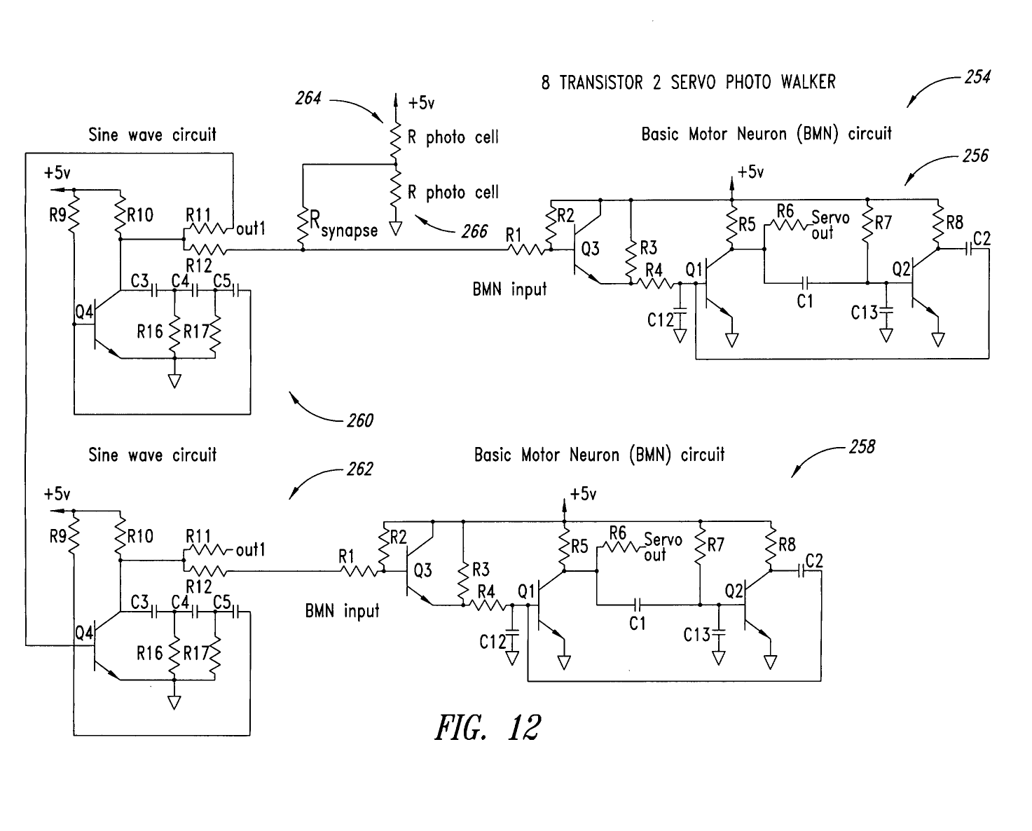

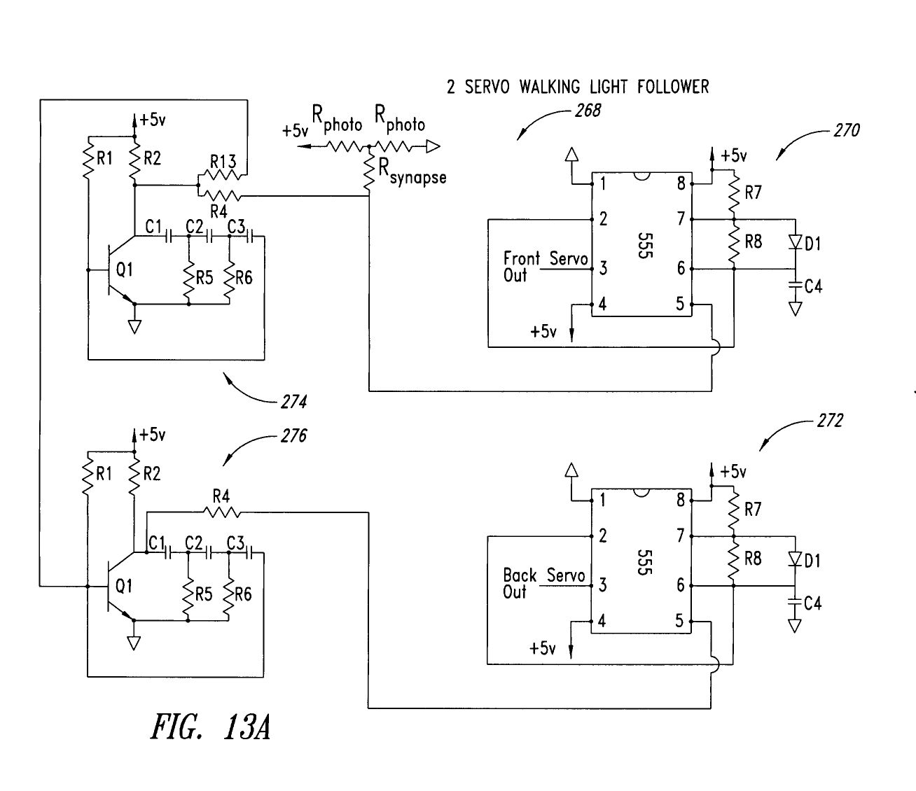

FIG. 12 is an electrical schematic for an eight-transistor two-servo photowalker. This schematic shows the control circuitry 254 having a high impedance to facilitate analog sensors, photocells, tough sensors, heat sensors, and the like. FIG. 12 shows the use of two basic motor neuron circuits 256 and 258 coupled to corresponding central pattern generators 260, 262, respectively, that are lightly coupled together in a master-slave relationship. These circuits correspond to the basic motor neuron circuit and central pattern generator described above with respect to FIGS. 1 and 2.

An additional element is the use of photocells 264, 266, shown as resistor R_{photocell1} and resistor R_{photocell2} coupled in series between a 5-volt voltage source and ground. The common node between the two photocells 264, 266 is coupled to the input of the basic motor neuron circuit 256 via a resistor R_{synapse}.

The resistor R_{synapse} controls how much the photocells are enabled to influence the DC offset of the output from the central pattern generator 260. In the context of a robot, this controls which side the front leg swings on. Thus, a light-following or light-avoiding behavior can be accomplished. It is recommended that R_{synapse} have an initial value of 47 k ohm for this application or embodiment. R3's value will have a substantial influence on how far the servo will cause the robotic limb to move. A potentiometer is recommended to initially obtain the desired results, after which a fixed resistance can be substituted. It is also to be understood that 555 timer circuits described above can be substituted for the basic motor neuron circuits 256, 258 illustrated herein.

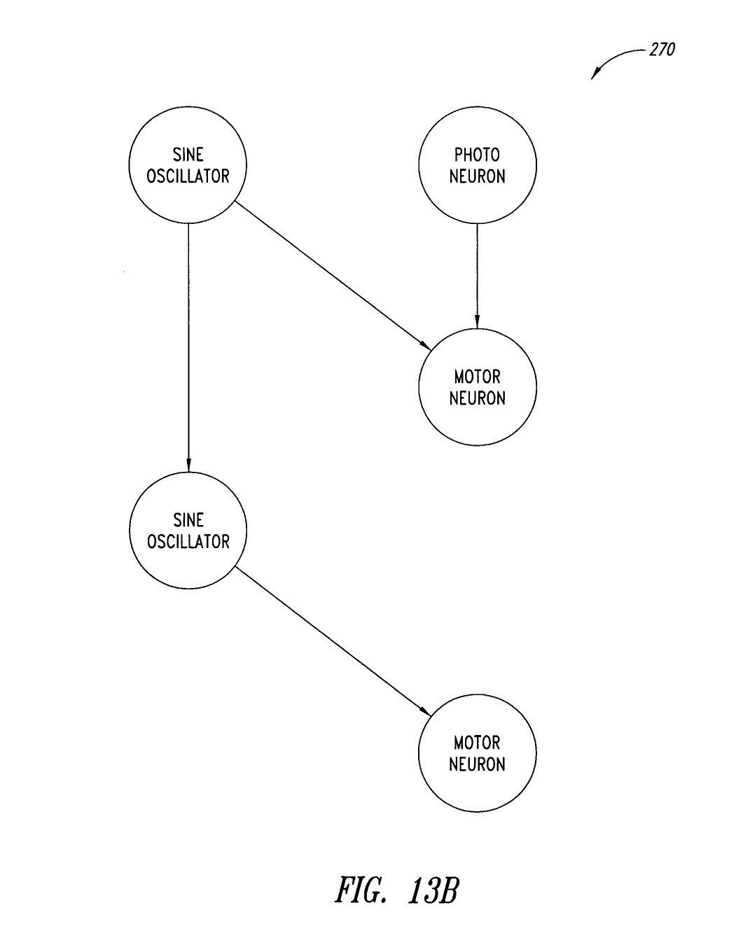

Turning next to FIGS. 13A and 13B, shown therein are a control circuit 268 and circuit topology 270, respectively, for a two-servo walking light-follower robot. This control circuit 268 is substantially similar to the control circuit 254 shown in FIG. 12, except it is using 555 chips in the basic motor neuron circuits 270, 272. This provides a lower impedance and enables the use of commercially available 555 chips. The two illustrated photocells create a DC offset modulator to the input of the first basic motor neuron circuit 270, which can function as the front servo. The resistor R_{synapse} determines the coupling's strength between the photocells R_{photocell1}, R_{photocell2}. It is recommended that a 10 k resistor be used initially for resistor R_{synapse} and then adjust as needed. Resistor R3 determines the amount of coupling between the two sine oscillator circuits 274, 276. Resistor R2 on the sine oscillator circuits 274, 276 can be adjusted to obtain a proper waveform.

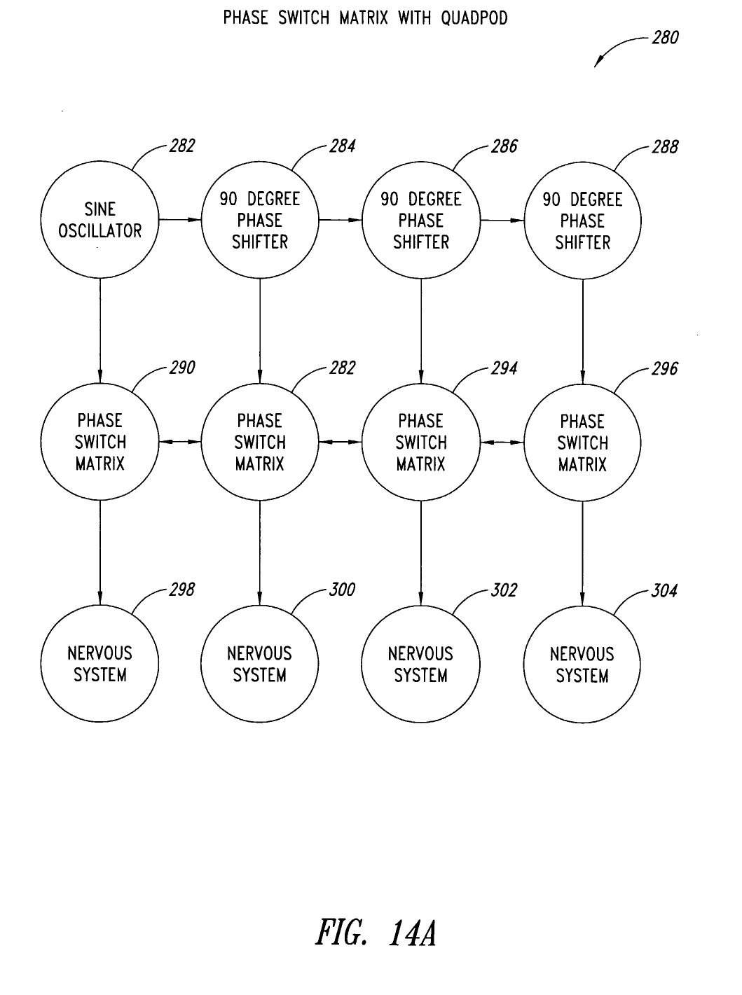

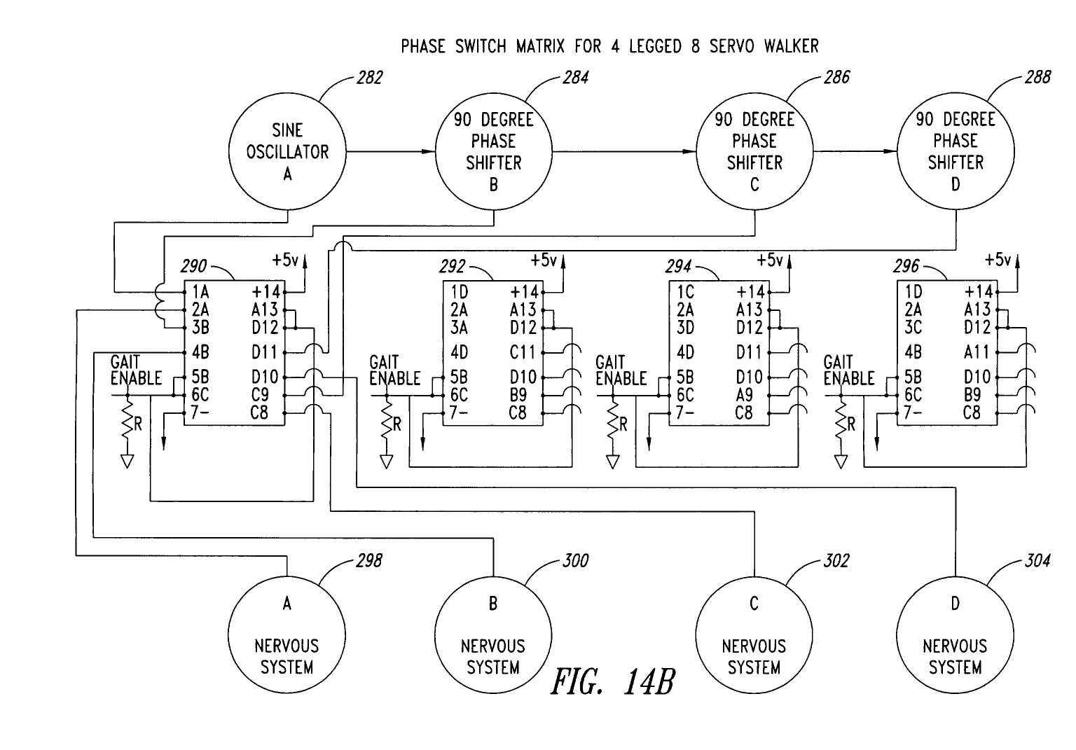

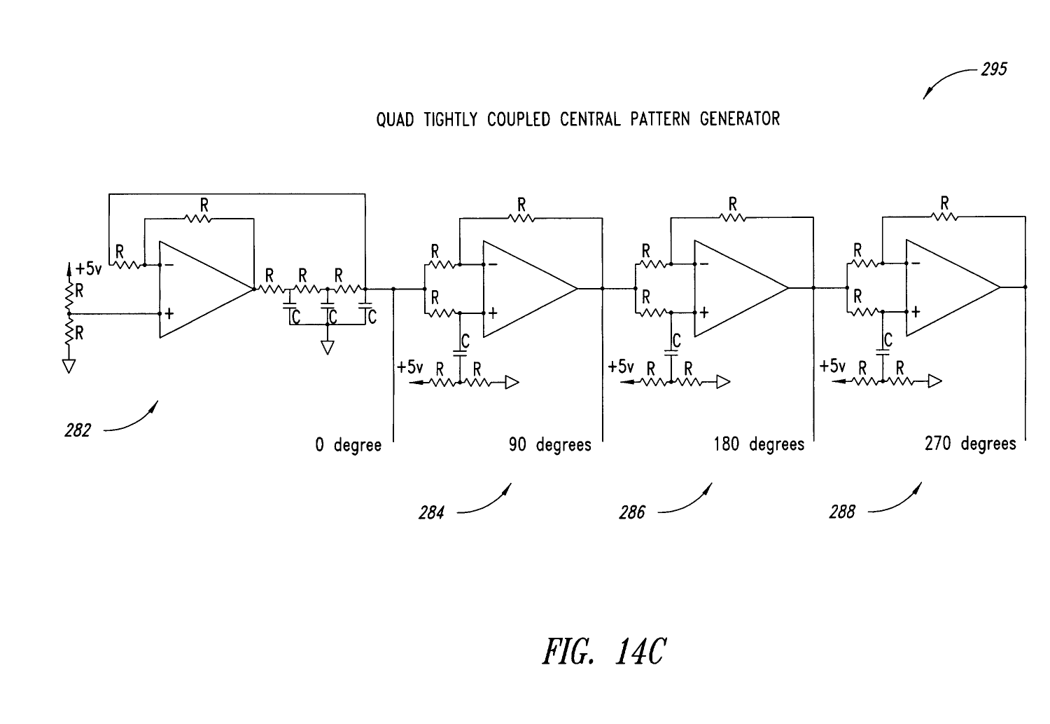

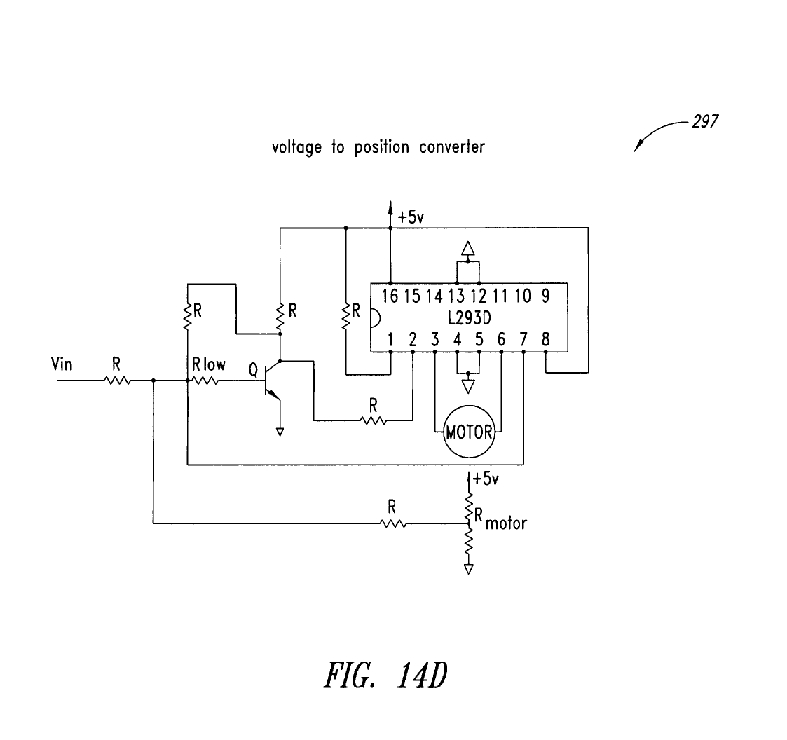

Referring next to FIG. 14A, shown therein is a phase switch matrix 280 for a four-legged quadropod. The circuit topology illustrated in FIG. 14A is similar to that used in the four-legged quadropod topology illustrated in FIG. 7, except instead of four separate sine oscillators, only one sine oscillator is used in combination with phase shifters fed through the phase switch matrix 280 to tap into different phases. Thus, all phases will be available. The sine oscillator 282 provides a sine wave output to three separate phase shifters 284, 286, 288 that each offset the sine oscillator output signal by 90 degrees and feed their outputs through respective phase switch matrix circuits 290, 292, 294, 296 that are also cross-coupled together. FIG. 14C shows in more detail the circuit schematics for one embodiment of a quad tightly-coupled central pattern generator 295 for this particular embodiment. FIG. 14B illustrates one embodiment of the phase switch matrix circuits 290, 292, 294, 296 utilizing four 4066 quad analog switches.

The outputs of the phase switch matrix circuits 290, 292, 294, 296 are fed to respective nervous system components, such as respective basic motor neuron circuits as described above and associated voltage-to-position converters, such as the voltage-to-position circuit 297 illustrated in FIG. 14D. The voltage-to-position converter circuit 297 is an exemplary circuit, and it is to be understood that various alternatives to this circuit that are application-dependent can be used. This circuit has a tri-state input wherein a low voltage will actuate the motor in a first direction of rotation, a higher mid-level voltage is the deadband, and a further higher voltage makes the motor rotate in an opposite second direction. The dead band range is adjustable depending on the resistance of the bias resistors. The resistor Rmotor is a potentiometer coupled to the motor shaft and provides the feedback for the circuit. This circuit can replace the basic motor neuron circuit and the circuit found in the radio controlled aircraft-type servos such that any DC gearhead motor can be used. The DC gearhead motor may function as a rotational or linear voltage to position converter depending on how it's set up. Furthermore, the DC gearhead motor may be replaced with any actuator that is bi-directional (e.g. pistons)

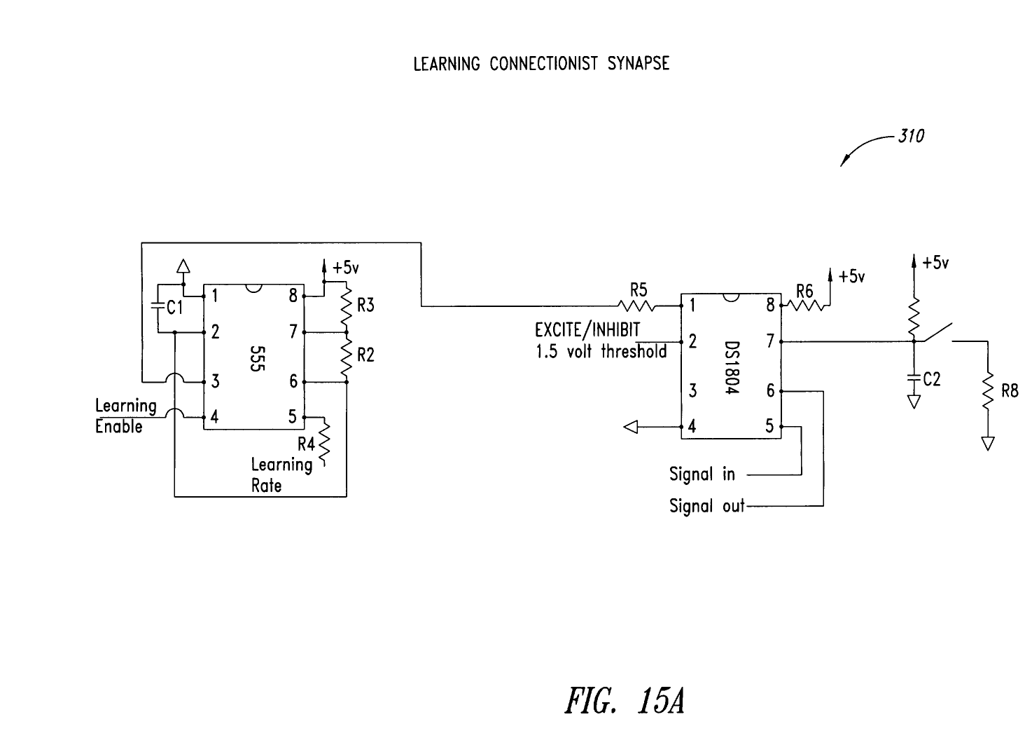

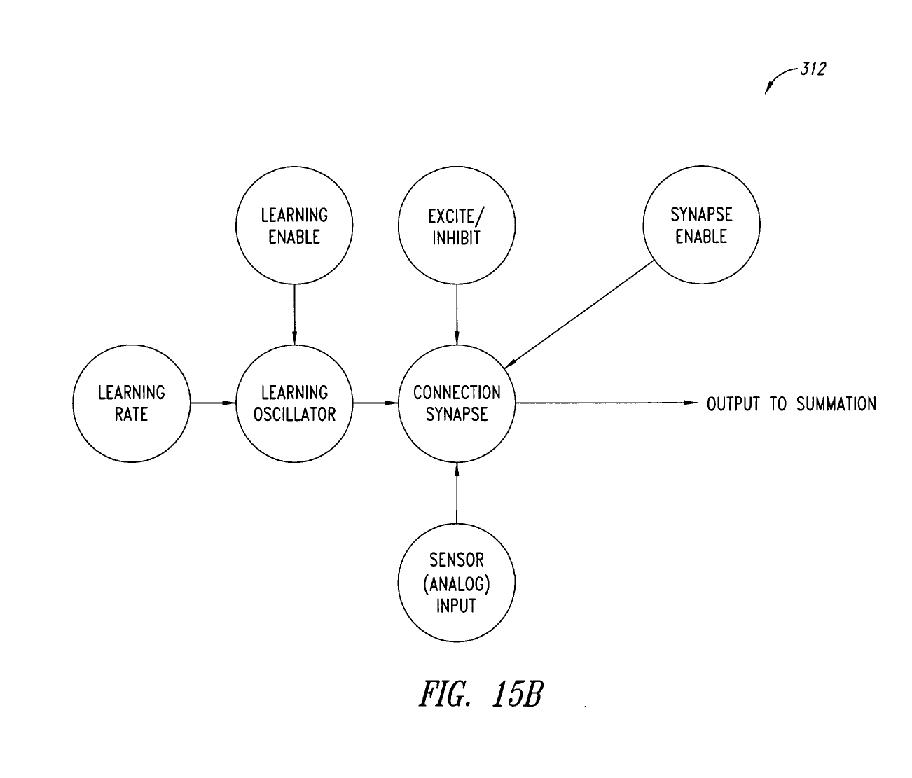

FIGS. 15A and 15B illustrate a learning connectionist synapse circuit 310 and related circuit topology 312, respectively. The circuit 310 includes a 555 timer chip having the first pin coupled to ground and also coupled to the second pin via a first capacitor C1. The second pin is also coupled to the sixth pin directly and to the seventh pin through resistor R2 and to the eighth pin through resistor R3. The eighth pin is coupled to a 5-volt voltage source. The fifth pin is coupled to a learning rate node through resistor R4. The fourth pin is coupled to a learning enable node directly. Pin 3 couples the 555 timer chip to a DS1804 EEPROM chip at pin 1 thereof by resistor R5. This is the clock input for the DS1804 chip. Pin 2 of this chip is coupled to a 1.5-volt threshold excite/inhibit signal source. Pin 3 is not connected, while pin 4 is coupled to ground. Pin 5 functions as a signal input and pin 6 is the signal output. Pin 8 is coupled to the 5-volt voltage source through resistor R6. Pin 7 is coupled to the 5-volt voltage source through resistor R7 and to ground through capacitor C2. It is also coupled to ground through resistor R8 and switch Sw1.

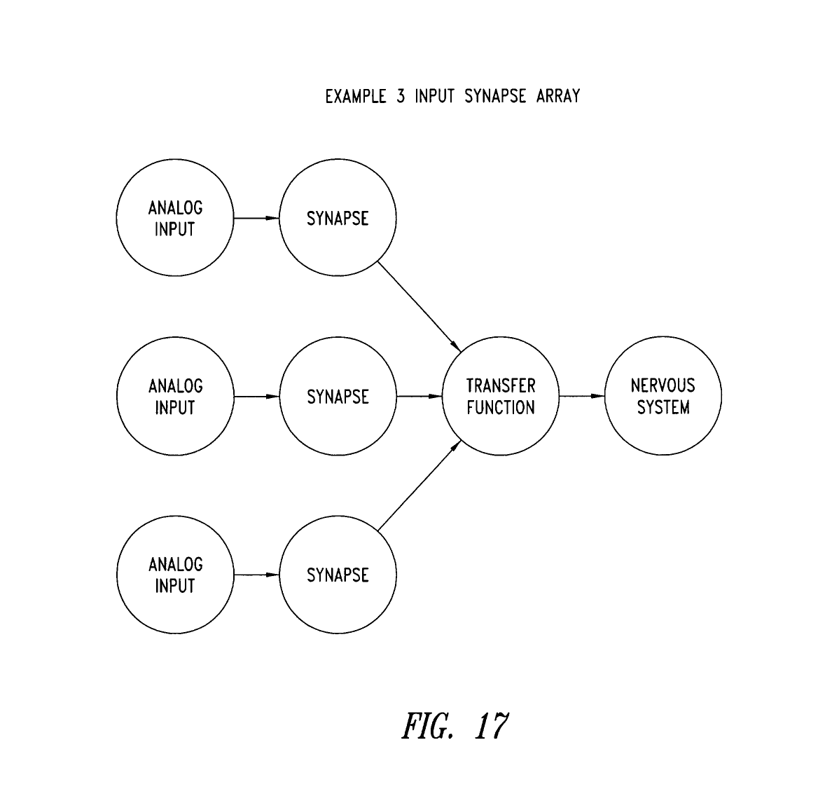

The learning connectionist synapse 310 functions as a variable resistor, i.e., a rheostat and not a potentiometer. An array of the synapses is illustrated in FIG. 17.

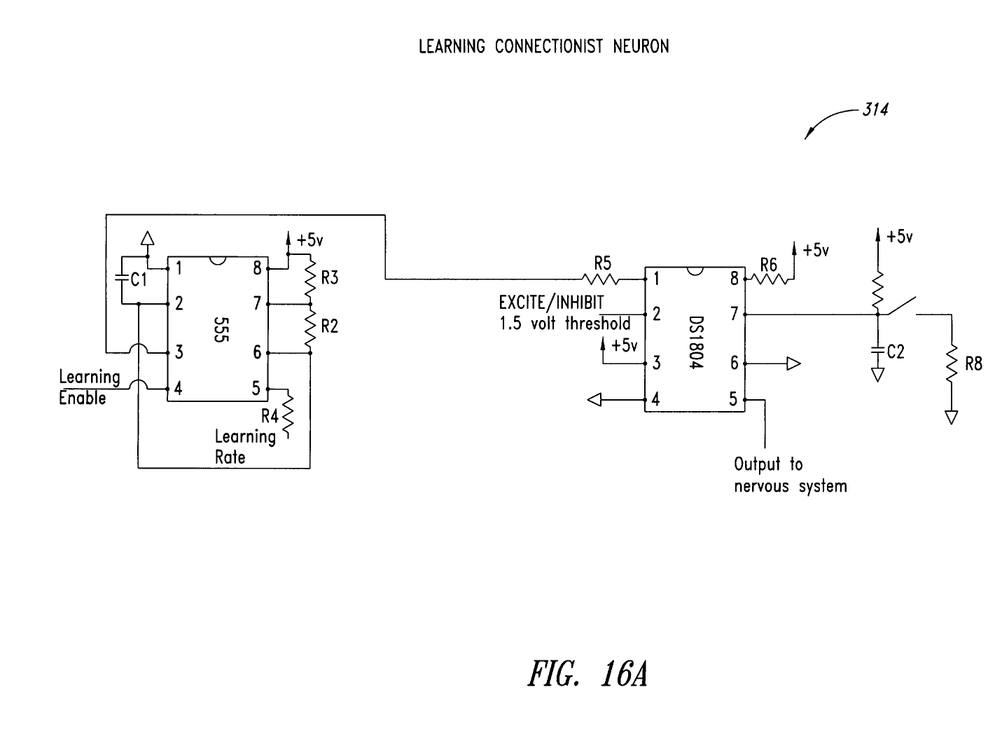

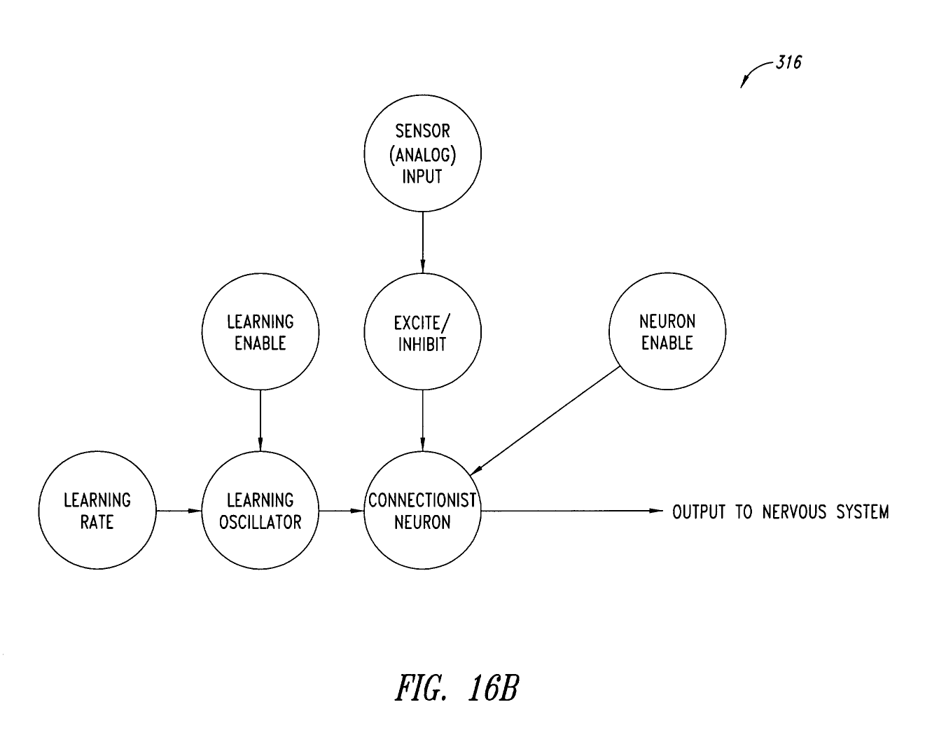

Turning to FIG. 16B, shown therein is a learning connectionist neuron circuit 314 and related topology 316, respectively. The circuit 314, which is very similar to the synapse circuit 310 described in conjunction with FIGS. 15A and 15B, has pin 3 coupled to a 5-volt voltage source and pin 6 coupled to ground. Pin 5 is the output to the nervous system. As shown in the topology of FIG. 16B, the connectionist neuron receives input from the excite/inhibit input that in turn receives input from a sensor, such as an analog sensor. The connectionist neuron is controlled by a neuron enable signal to thus function as a potentiometer and not a rheostat. This circuit provides non-volatile changes to behavior. The 555 chip provides voltage-controlled pulses. The higher the frequency of the learning rate input, the higher the learning rate. However, too high of a frequency throws the system into oscillations. For example, it will cause a robot to overshoot and overcorrect repeatedly.

The synapse circuit 310 and neuron circuit 314 provide non-volatile long-term memory. The synapse can be input to the excite/inhibit of the neuron. It modifies impedance of the sensor/analog input, influencing the weight of the sensor input. Multiple layers of synapse can be provided for non-linearity in the control system and greater flexibility. The neuron circuit 314 generates an output voltage and acts as a potentiometer instead of a rheostat.

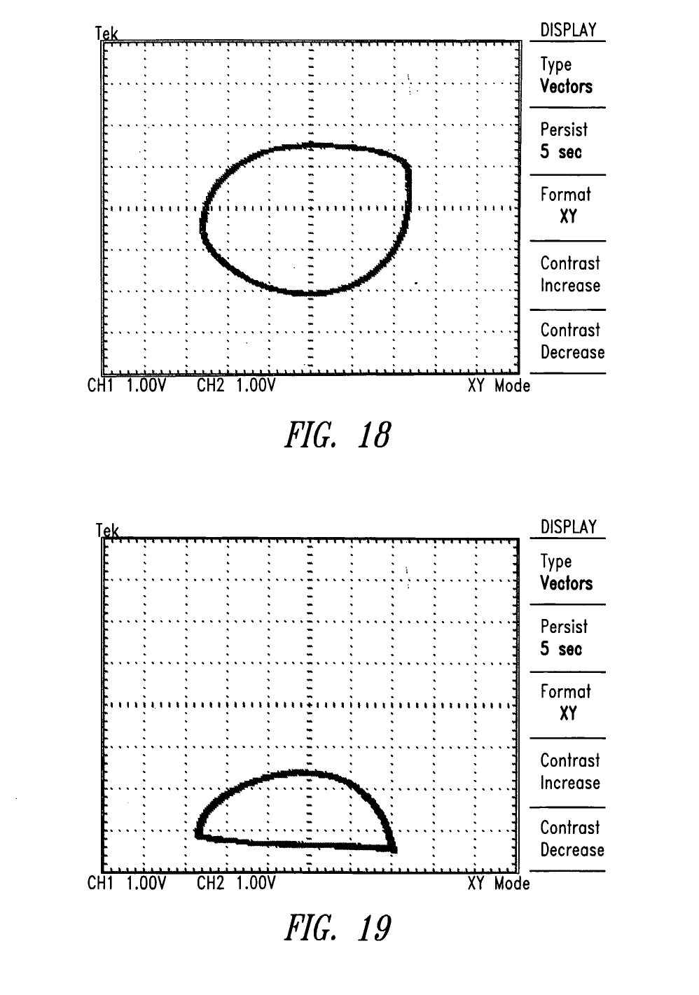

With respect to waveforms, FIG. 18 illustrates a waveform output from the central pattern generator circuit 48 of FIG. 2 using OUT1 and OUT2 62, 86, respectively, as the X and Y inputs. This is a period 1 illustration, which is useful for general-purpose robotics, such as swimming.

FIG. 19 shows a variation of the period 1 signal to create longer contract with a surface. For example, this variation of the period 1 waveform would be useful with the four-legged, eight-servo quadropod (loads, racing, etc.).

FIG. 20 is an oscilloscope waveform display of period 4 showing variability in the output over time. While it is fairly stable, it would be useful for providing variation in stride on soft surfaces, such as sand, to prevent the robot from becoming stuck in the sand.

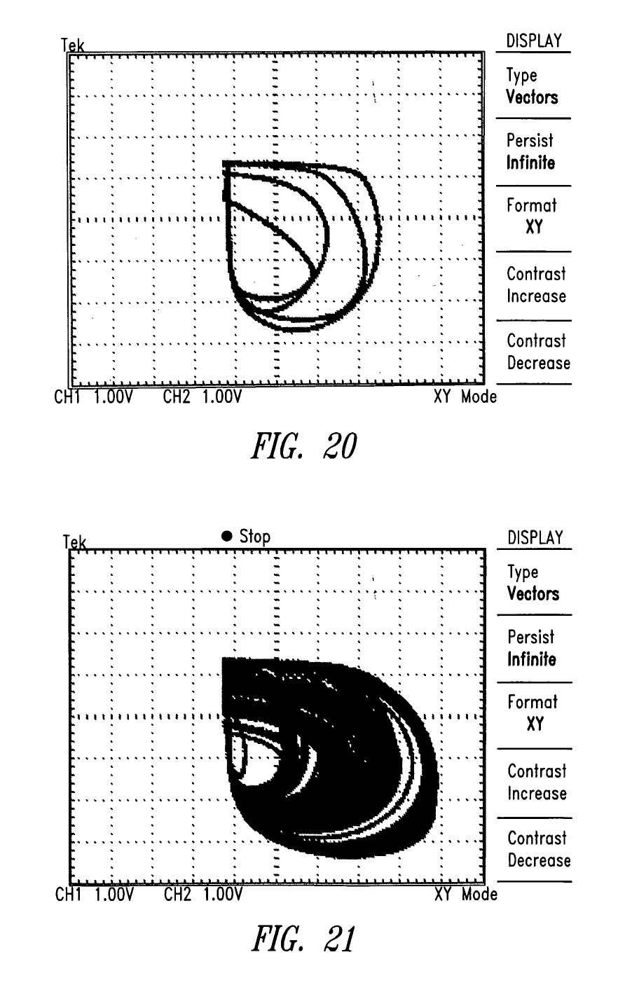

FIG. 21 is an oscilloscope waveform display of a chaotic generator having some stability for providing more life-like, dynamic use.

While preferred embodiments of the invention have been illustrated and described, it is to be understood that various changes can be made therein without departing from the scope of the invention. For example, the basic motor neuron circuit can use the 555 chip, as described above, or this chip can be replaced with a microcontroller chip that generates the proper signal. While such a chip provides less space, it does increase cost.

While the present invention has been illustrated and described in conjunction with servos, such as off-the-shelf servos used in radio-controlled vehicles, it is to be understood that the present invention is applicable with any voltage-to-position converter. DC gearhead motors can be changed out for pneumatics and hydraulics, so long as there is analog feedback, such as a potentiometer, in order to know the position of the movable part.

Also, a master oscillator having an op amp phase shifter may be more appropriate in some situations. In addition, although bipolartransistors have been illustrated and NPN and other integrated transistors have been described, it is to be understood that bipolar or integrated transistors may be used exclusively or in any combination thereof. Hence, the invention is to be limited only by the scope of the claims that follow and the equivalents thereof.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A control circuit for an actuator, comprising:
an analog central pattern generator circuit structured to generate a sine wave control signal at an output; and
an analog multi-vibrator circuit having an input coupled to the output of the central pattern generator and an output configured to be coupled to the actuator, the multi-vibrator circuit structured to generate a sine-variable rectangular wave signal in response to the control signal from the central pattern generator to drive the servo in a sine movement pattern.

2. The circuit of claim 1, wherein the analog multi-vibrator circuit comprises:
a first transistor having a control terminal coupled to an input, a first terminal coupled to a voltage source and a second terminal;
a second transistor having a control terminal coupled to the second terminal of the first transistor, a first terminal coupled to the voltage source and to an output, and a second terminal coupled to a reference voltage; and
a third transistor having a control terminal coupled to the output and to the voltage source, a first terminal coupled to the voltage source, and a second terminal coupled to the reference voltage.

3. The circuit of claim 1, wherein the analog control pattern generator comprises:
a master section pattern generator having a master section that includes a master transistor having
a first terminal coupled to a master output and a voltage source
a control, coupled to the voltage source, and a second terminal coupled to a master timing circuit having a master timing output coupled to the control terminal; and
a slave section coupled to the master section and including a slave resistor having a control terminal coupled to the voltage source and to the master output, a first terminal coupled to a slave output and the voltage source, and a second terminal coupled to a slave timing circuit having a slave timing output coupled to the control terminal of the slave transistor.

4. The circuit of claim 3, wherein the transistors comprise bipolar transistors.

5. The circuit of claim 3, wherein the central pattern generator comprises a resistor coupled between the master output and the slave output.

6. The circuit of claim 3, wherein the master and slave timing circuits each comprise an RC network.

7. The circuit of claim 3, further comprising a voltage-controlled resistive circuit coupled to the RC network of the master timing circuit to modulate an output frequency of the central pattern generator.

8. The circuit of claim 7, wherein the voltage-controlled resistive circuit comprises a first transistor having a control terminal coupled to the voltage source, a first terminal coupled to the voltage source and to an output, and to frequency modulate an output of the central pattern generator.

9.-17. (canceled)

18. A basic motor neuron circuit, comprising:
a first transistor having a control terminal coupled to an input, a first terminal coupled to a voltage source and a second terminal;
a second transistor having a control terminal coupled to the second terminal of the first transistor, a first terminal coupled to the voltage source and to an output, and a second terminal coupled to a reference voltage; and
a third transistor having a control terminal coupled to the output and to the voltage source, a first terminal coupled to the voltage source, and a second terminal coupled to the reference voltage.

19. The circuit of claim 18, further comprising a first capacitor coupled between the control terminal of the third transistor and the output, and a second capacitor coupled between the first terminal of the third transistor and the control terminal of the second transistor, the first and second capacitors configured to control timing for the circuit.

20. The circuit of claim 18, further comprising a first resistor and a second resistor coupled in series between the control terminal of the second transistor and the voltage source and configured to control a pulse width of a pulse signal generated on the output.

21. A robotic machine, comprising:
at least one movable component coupled to a servo that generates movement of the component;
a control circuit coupled to the servo for controlling actuation of the servo, the control circuit comprising:
a first transistor having a control terminal coupled to an input, a first terminal coupled to a voltage source and a second terminal;
a second transistor having a control terminal coupled to the second terminal of the first transistor, a first terminal coupled to the voltage source and to an output, and a second terminal coupled to a reference voltage; and
a third transistor having a control terminal coupled to the output and to the voltage source, a first terminal coupled to the voltage source, and a second terminal coupled to the reference voltage.

22. The machine of claim 21, further comprising a first capacitor coupled between the control terminal of the third transistor and the output, and a second capacitor coupled between the first terminal of the third transistor and the control terminal of the second transistor, the first and second capacitors configured to control timing for the circuit.

23. The machine of claim 21, further comprising a first resistor and a second resistor coupled in series between the control terminal of the second transistor and the voltage source and configured to control a pulse width of a pulse signal generated on the output.

24. A synthetic nervous system for robotic locomotion, comprising:
a central pattern generator having a pair of phase-coupled sine wave oscillators generating at least two output signals;
at least one motor neuron circuit coupled to the central pattern generator to receive at least one output therefrom; and
at least one servo coupled to the motor neuron circuit to receive an actuation signal therefrom.

25. The system of claim 24, further comprising one or more of an amplitude circuit, a DC offset circuit, a frequency generator circuit, and a variable phase circuit coupled to the central pattern generator and the motor neuron circuit for controlling amplitude, offset, frequency, and phase operation of the motor neuron circuit.

26. The system of claim 24, wherein the central pattern generator comprises a master section that includes a master transistor having a first terminal coupled to a master output and a voltage source, a control, coupled to the voltage source, and a second terminal coupled to a master timing circuit having a master timing output coupled to the control terminal; and
a slave section coupled to the master section and including a slave resistor having a control terminal coupled to the voltage source and to the master output, a first terminal coupled to a slave output and the voltage source, and a second terminal coupled to a slave timing circuit having a slave timing output coupled to the control terminal of the slave transistor.

27. The system of claim 26, wherein the transistors comprise bipolar transistors.

28. The system of claim 26, wherein the central pattern generator comprises a resistor coupled between the master output and the slave output.

29. The system of claim 26, wherein the master and slave timing circuits each comprise an RC network.

30. The system of claim 26, further comprising a voltage-controlled resistive circuit coupled to the RC network of the master timing circuit to modulate an output frequency of the central pattern generator.

31. The system of claim 26, wherein the voltage-controlled resistive circuit comprises a first transistor having a control terminal coupled to the voltage source, a first terminal coupled to the voltage source and to an output, and to frequency modulate an output of the central pattern generator.

32. The system of claim 24, further comprising one or more of an amplitude circuit, a DC offset circuit, a frequency generator circuit, and a variable phase circuit coupled to the central pattern generator and the motor neuron circuit for controlling amplitude, offset, frequency, and phase operation of the motor neuron circuit.

33. A synthetic nervous system for robotic locomotion, comprising:
a motor neuron circuit having first and second transistors coupled together to function as a multi-vibrator, a third transistor configured as a voltage-variable resistor providing input to the motor neuron circuit, and an output on which is generated a pulse train signal providing input to the motor neuron circuit, and an output on which is generated a pulse train signal responsive to an input signal.

34. The system of claim 33, further comprising a central pattern generator having a master section that includes a master transistor having a first terminal coupled to a master output and a voltage source, a control, coupled to the voltage source, and a second terminal coupled to a master timing circuit having a master timing output coupled to the control terminal; and
a slave section coupled to the master section and including a slave resistor having a control terminal coupled to the voltage source and to the master output, a first terminal coupled to a slave output and the voltage source, and a second terminal coupled to a slave timing circuit having a slave timing output coupled to the control terminal of the slave transistor.

35. The system of claim 34, wherein the transistors comprise bipolar transistors.

36. The system of claim 34, wherein the central pattern generator comprises a resistor coupled between the master output and the slave output.

37. The system of claim 34, wherein the master and slave timing circuits each comprise an RC network.

38. The system of claim 34, further comprising a voltage-controlled resistive circuit coupled to the RC network of the master timing circuit to modulate an output frequency of the central pattern generator.

39. The system of claim 38, wherein the voltage-controlled resistive circuit comprises a first transistor having a control terminal coupled to the voltage source, a first terminal coupled to the voltage source and to an output, and to frequency modulate an output of the central pattern generator.
